(19) United States
(12) Patent Application Publication
(10) Pub. No.: US 2026/0225403 A1
(43) Pub. Date: Aug. 6, 2026

(54) TIRE WITH AN IMPROVED INTERFACE

(71) Applicant: COMPAGNIE GENERALE DES ETABLISSEMENTS MICHELIN, Clermont-Ferrand (FR)

(72) Inventors: SABRINA SCHMITT, Clermont-Ferrand (FR); AYMERIC BONNET, Clermont-Ferrand (FR)

(21) Appl. No.: 19/147,105

(22) PCT Filed: Nov. 16, 2023
(86) PCT No.: PCT/EP2023/082017

§ 371 Date: Jul. 10, 2025

(30) Foreign Application Priority Data
Jan. 11, 2023 (FR) FR2300255

(51) Int. Cl. B60C 9/08; B60C 9/02; B60C 13/00; B60C 15/04

(52) U.S. Cl. CPC B60C 9/08; B60C 13/00; B60C 15/04; B60C 2009/0276; B60C 2013/006; B60C 2015/044; B60C 2200/04

(57) ABSTRACT

The tire for a passenger vehicle comprises a reinforced layer (36) and a stiffening layer (44) extending radially from the beads (32) into the sidewalls (30). The stiffening layer (44) is arranged axially between the reinforced layer (36) and the external layer (42) of the sidewall (30), in contact with the reinforced layer (36) and in contact with a part of the external layer (42) of the sidewall (30). The ratio R of the modulus MA100R at 100% elongation of the polymeric matrix of the reinforced layer (36) to the modulus MA10B at 10% elongation of the stiffening layer (44) is such that R× 1000≥(0.011×MA10B×MA10B)−1.71×MA10B+86.70.

The present invention relates to a tyre. A tyre is understood to be a casing intended to form a cavity by cooperating with a support element, for example a rim, this cavity being able to be pressurized to a pressure higher than atmospheric pressure. A tyre according to the invention has a structure of substantially toroidal shape exhibiting symmetry of revolution about a main axis of the tyre.

A tyre for a passenger vehicle comprising a crown, two beads, and two sidewalls connecting each bead to the crown is known from the prior art. The tyre also comprises a carcass reinforcement comprising one or more carcass layers anchored in each bead. The crown also comprises a crown reinforcement, the or each carcass layer extending radially in each sidewall and axially in the crown, radially to the inside of the crown reinforcement. The or each carcass layer comprises reinforcing elements embedded in a polymeric matrix.

The tyre also comprises stiffening layers extending radially from each bead into each sidewall adjacent to said bead. In each adjacent sidewall, the stiffening layer is arranged axially between the axially outermost carcass layer and the external layer of the sidewall bearing the external surface of the sidewall. In each sidewall, the stiffening layer is arranged in contact with a part of the axially outermost carcass layer in each sidewall and in contact with a part of the external layer of each sidewall.

In particular under unusually demanding use conditions, particularly under conditions of high load and/or pressure lower than the recommended pressure, a significant increase in energy dissipation and an increase in temperature at the interface between the stiffening layer and the axially outermost carcass layer have been observed.

The aim of the invention is to control the energy dissipation and the increase in temperature between the stiffening layer and the axially outermost carcass layer, in particular under unusually demanding use conditions.

To this end, the subject of the invention is a tyre for a passenger vehicle, comprising:
a crown, two beads, two sidewalls connecting each bead to the crown, each sidewall comprising an external layer of said sidewall bearing an external surface of said sidewall, a reinforced layer extending radially in at least one of the sidewalls and comprising filamentary reinforcing elements embedded in a polymeric matrix,
a stiffening layer extending radially from one of the beads into the sidewall adjacent to said bead, the stiffening layer being arranged, in said sidewall:
   axially between the reinforced layer and the external layer of said sidewall, and
   in contact with at least a part of the reinforced layer and in contact with at least a part of the external layer of said sidewall,
      the ratio R of the modulus MA100R at 100% elongation of the polymeric matrix of the reinforced layer to the modulus MA10B at 10% elongation of the stiffening layer being such that R×1000≥(0.011×MA10B× MA10B)−1.71×MA10B+86.70.

The tyre according to the invention exhibits a relatively low increase in temperature and energy dissipation, even under unusually demanding use conditions. Specifically, the inventors have found that by limiting the difference between the modulus of the operating point of the polymeric matrix of the reinforced layer and the modulus of the operating point of the stiffening layer, the difference in stresses at the interface between the polymeric matrix of the reinforced layer and the stiffening layer was limited. However, the operating point of the polymeric matrix of the reinforced layer is located at relatively high elongations, whereas the operating point of the stiffening layer is located at relatively low elongations. The moduli at 100% and at 10% elongation, respectively, are thus representative of the operating points of the reinforced layer and of the stiffening layer. Therefore, the inventors behind the invention have determined that the ratio R was representative of the sensitivity of the interface between the polymeric matrix of the reinforced layer and the stiffening layer. For a given value of the modulus MA10B, the higher the ratio, the less the interface is sensitive.

To explain this, the inventors assume that by increasing the value of the ratio R for a given value of the modulus MA10B, the difference in stresses at the interface causing the energy dissipation and the increase in temperature is limited.

The stiffening layer extends radially from one of the beads into the sidewall adjacent to said bead. Thus, the stiffening layer is present partially in the sidewall and partially in the bead, the proportions of one of the parts in relation to the other varying depending on the tyre in question and the performance aspects that a person skilled in the art wishes to confer on the tyre.

The stiffening layer does not delimit the external surface of said sidewall.

The external surface is the surface of the tyre that is in contact with air at atmospheric pressure and is visible from the outside of the tyre.

As regards the modulus MA10B at 10% extension, this is the elastic modulus of the compound measured during uniaxial tensile testing, at an elongation value of 0.1 (i.e. 10% elongation, expressed as a percentage). Uniaxial tension is applied to the test specimen at a constant rate, and the elongation and the force are measured. The measurements are taken using an INSTRON type tensile tester, at a temperature of 23° C., and a relative humidity of 50% (standard ISO 23529). The conditions for measuring and for using the results in order to determine elongation and stress are as described in the standard NF ISO 37:2012-03. The stress is determined for an elongation of 0.1 and the modulus of elasticity under tension at 10% elongation is calculated by determining the ratio of this stress value to the elongation value. A person skilled in the art will know how to choose and adapt the dimensions of the test specimen according to the quantity of compound accessible and available in particular in the case of test specimens taken from the tyre. The modulus MA100R is determined in the same way, mutatis mutandis.

When it is possible to determine the moduli MA10B and MA100R on the tyre, the moduli MA10B and MA100R are measured on the polymeric matrix and the stiffening layer delimiting the interface between the reinforced layer and the stiffening layer located in the sidewall.

Preferably, the polymeric matrix is an elastomeric matrix.

Preferably, unlike the reinforced layer, the stiffening layer does not comprise any filamentary reinforcing elements embedded in the stiffening layer. Thus, preferably, the stiffening layer is made up of a polymeric compound, preferably an elastomeric compound. Such stiffening compounds are known in particular from EP0678404 and WO2010072736.

The expression “filamentary reinforcing element” means an element providing mechanical reinforcement to the polymeric matrix in which this reinforcing element is intended to be embedded. Each reinforcing element is filamentary, meaning that the element has a length at least 10 times greater than the largest dimension of its cross section, regardless of the shape of the latter: circular, elliptical, oblong, polygonal, in particular rectangular or square or oval. In the case of a rectangular cross section, the filamentary reinforcing element has the shape of a strip.

The matrix or the compound is said to be polymeric because it is based on a polymeric composition, this polymeric composition possibly comprising one or more polymers, for example selected from thermoplastic polymers, thermosetting polymers, elastomers, thermoplastic elastomers, and also fillers and other components usually used in the field of compositions for tyres, in particular compositions for embedding filamentary reinforcing elements or for the stiffening layers.

The expression “sidewall adjacent to a bead” means the sidewall arranged on the same side of the median plane of the tyre as the side on which the bead is located.

The tyre according to the invention has a substantially toroidal shape about an axis of revolution substantially coincident with the axis of rotation of the tyre. This axis of revolution defines three directions conventionally used by those skilled in the art: an axial direction, a circumferential direction and a radial direction.

The expression “axial direction” means the direction substantially parallel to the axis of revolution of the tyre, that is to say the axis of rotation of the tyre.

The expression “circumferential direction” means the direction that is substantially perpendicular both to the axial direction and to a radius of the tyre (in other words, tangent to a circle centred on the axis of rotation of the tyre).

The expression “radial direction” means the direction along a radius of the tyre, that is to say any direction that intersects the axis of rotation of the tyre and is substantially perpendicular to that axis.

The expression “median plane of the tyre” (denoted M) means the plane perpendicular to the axis of rotation of the tyre which is situated axially mid-way between the two beads and passes through the axial middle of the crown reinforcement.

The expression “equatorial circumferential surface of the tyre” means the combination of the planes passing, in each meridian section plane, through the equator (denoted E) of the tyre and perpendicular to the median plane and to the radial direction. The equator of the tyre is, in a meridian plane of section (plane perpendicular to the circumferential direction and parallel to the radial and axial directions), the axis that is parallel to the axis of rotation of the tyre and situated equidistantly between the radially outermost point of the tread that is intended to be in contact with the ground and the radially innermost point of the tyre that is intended to be in contact with a support, for example a rim.

The expression “meridian plane” means a plane parallel to and containing the axis of rotation of the tyre and perpendicular to the circumferential direction.

The expressions “radially inner/inside” and “radially outer/outside” mean closer to the axis of rotation of the tyre and further away from the axis of rotation of the tyre, respectively. The expressions “axially inner/inside” and “axially outer/outside” mean closer to the median plane of the tyre and further away from the median plane of the tyre, respectively.

The term “bead” means the portion of the tyre intended to allow the attachment of the tyre to a mounting support, for example a wheel comprising a rim. Thus, each bead is in particular intended to be in contact with a flange of the rim allowing it to be attached. The radially outer end of the external surface of the bead of the tyre is defined as the radially outermost point on the external surface of the tyre in contact with a measuring rim of the tyre according to the ETRTO Standards Manual, 2021 when the tyre is inflated to its nominal pressure on this measuring rim. The bead and the sidewall are thus delimited by a straight line perpendicular to the external surface of the tyre at this point.

Any interval of values denoted by the expression “between a and b” represents the range of values extending from more than a to less than b (i.e. excluding the limits a and b), whereas any interval of values denoted by the expression “from a to b” means the range of values extending from a to b (i.e. including the strict limits a and b).

The tyres are intended for passenger vehicles as defined in the ETRTO Standards Manual, 2021. Such a tyre has a section in a meridian section plane that is characterized by a section height H and a nominal section width SW within the meaning of the ETRTO Standards Manual, 2021, such that, optionally, the ratio H/SW, expressed as a percentage, is at most equal to 90 and is at least equal to 20, and the nominal section width SW is at least equal to 185 mm and at most equal to 385 mm. Moreover, the diameter at the flange D, defining the diameter of the mounting rim of the tyre, is optionally at least equal to 14 inches and at most equal to 24 inches. Finally, and still optionally, the load index LI ranges from 80 to 116.

The sidewall height H is defined by H=SW×AR/100, where SW is the nominal section width and AR the nominal aspect ratio of the tyre, for example as indicated in the ETRTO Standards Manual, 2021.

Advantageously, the reinforced layer is the axially outermost layer in the or each sidewall. The axially outermost reinforced layer has, in a meridian section plane, the greatest curvilinear length of contact with the stiffening layer in the sidewall. Thus, given the continuity of the axially outermost reinforced layer, the axially outermost reinforced layer is the axially outermost reinforced layer in the greatest part of the sidewall. Generally, the axially outermost reinforced layer is the axially outermost layer at the equator.

In embodiments in which the two sides of the tyre are provided with the invention, the tyre comprises:
one or more reinforced layer(s) extending radially in each sidewall, the or each reinforced layer comprising filamentary reinforcing elements embedded in a polymeric matrix,
two stiffening layers arranged on each side of the median plane of the tyre, each stiffening layer extending radially from each bead into each sidewall adjacent to said bead, respectively, each stiffening layer being arranged in said sidewall:
   axially between the reinforced layer and the external layer of said sidewall, and
   in contact with at least a part of the reinforced layer and in contact with at least a part of the external layer of said sidewall,
      the ratio R of the modulus MA100R at 100% elongation of the polymeric matrix of the reinforced layer to the modulus MA10B at 10% elongation of the stiffening layer arranged in said sidewall being such that R×1000≥(0.011×MA10B× MA10B)−1.71×MA10B+86.70.

In optional but advantageous embodiments, R×1000≥(0.0106×MA10B× MA10B)− 1.72×MA10B+90.40.

In optional but advantageous embodiments, R×1000≤(0.0127×MA10B× MA10B)− 2.03×MA10B+109.

In optional but advantageous embodiments, MA10B≥30.0 MPa, preferably MA10B≥40.0 MPa and more preferably 40.0 MPa≤MA10B≤70.0 MPa. On account of its great stiffness, such a stiffening layer makes it possible to improve the dynamic behaviour of the tyre by stiffening the region in which it is located. In particular, it makes it possible to improve the cornering stiffness of the tyre.

In optional but advantageous embodiments, MA100R≥1.0 MPa, preferably MA100R≥1.5 MPa.

In optional but advantageous embodiments, MA100R≤2.5 MPa, preferably MA100R≤2.0 MPa.

Embodiments are particularly sensitive to energy dissipation and the increase in temperature between the stiffening layer and the axially outermost carcass layer. This is because the development of electric or hybrid passenger vehicles has seen an increase in the weight of vehicles, in particular on account of the batteries, which have a relatively high weight substantially proportional to the range of the vehicles. Thus, for example, in order to increase the range of an electric vehicle, it is necessary to increase the size of its batteries and, as a result, the weight of the vehicle. Simply put, it is currently estimated that each kilometre of range of an electric motor increases the weight of the vehicle by one kilogram. Thus, in order to achieve a range of 500 kilometres, it is necessary to increase the weight of a vehicle with combustion engine propulsion by approximately 500 kg. Such vehicles need to be fitted with tyres capable of bearing a very high load. Thus, tyre manufacturers have decided to create a new type of tyre. This new type is now known under the designation HIGH LOAD CAPACITY in the ETRTO Standards Manual, 2021. This new type of tyre makes it possible to ensure that the load that the tyre of a given size is capable of bearing is higher than that which a tyre of the same size, but in its STANDARD LOAD version or in its EXTRA LOAD version, would be capable of bearing. For the 255/35R18 size, the tyre of the HIGH LOAD CAPACITY type thus has a load index equal to 98, indicating that it is capable of bearing a load of 750 kg at a pressure of 290 kPa. In its EXTRA LOAD version, a tyre of size 255/35R18 has a load index equal to 94. This means that, at a pressure of 290 kPa, the tyre is capable of bearing a load of 670 kg. In its STANDARD LOAD version (abbreviated to SL), a tyre of size 255/35R18 has a load index equal to 90 and is capable of bearing a load of 600 kg at a pressure of 250 kPa.

Thus, the tyres of the HIGH LOAD CAPACITY type, owing to the relatively high load that they are required to bear, are required to operate under very demanding use conditions, in particular high load conditions. Thus, it is particularly advantageous that the tyre of the invention is, in certain embodiments, a tyre of the HIGH LOAD CAPACITY type according to the ETRTO Standards Manual, 2021.

By increasing the load index of the tyre of the invention relative to the load index of a tyre of the same size in its EXTRA LOAD version, the tyre of the HIGH LOAD CAPACITY type makes it possible to increase the load-bearing capacity of the mounted assembly without modifying the roominess, compactness and comfort of the vehicle on which it is used. Specifically, since the size of the tyre is identical to that of the tyre in its EXTRA LOAD version, the mounted assembly does not take up any more space than the tyre in its EXTRA LOAD version. A tyre of the HIGH LOAD CAPACITY type may bear a distinctive marking for distinguishing it from its STANDARD LOAD version and from its EXTRA LOAD version, for example a marking of the type HL (for HIGH LOAD) or XL+ (for EXTRA LOAD+). Such a marking is disclosed in particular in the ETRTO Standards Manual, 2021, on page 3 of the section General Notes-Passenger Car Tyres. Examples of sizes of tyres of the HIGH LOAD CAPACITY type are also disclosed in the ETRTO Standards Manual, 2021 on page 44, paragraph 9.1 in the section Passenger Car Tyres-Tyres with Metric Designation.

A tyre of the HIGH LOAD CAPACITY type may be characterized by its load index LI such that LI≥LI′+1, with LI′ being the load index of an EXTRA LOAD tyre of the same size according to the ETRTO Standards Manual, 2021. The load index LI′ is the load index of an EXTRA LOAD tyre of the same size, namely of the same nominal section width, the same nominal aspect ratio, the same structure (R and ZR being considered to be identical) and the same nominal rim diameter. The load index LI′ is given in the ETRTO Standards Manual, 2021, notably in the part entitled “Passenger Car Tyres-Tyres with Metric Designation”, pages 22 to 43. LI=LI′+1, or LI=LI′+2, or LI=LI′+3 or else LI=LI′+4, depending on the size. In most embodiments, LI′+1≤LI≤LI′+4, and even LI′+2≤LI≤LI′+4.

Technical solutions for designing tyres of the HIGH LOAD CAPACITY type are described in particular in WO2022/074341, WO2022/074342, WO2022/074343, WO2022/074344 and WO2022/074345.

Advantageously, the tyre has a sidewall height H defined by H=SW×AR/100, where SW is the nominal section width and AR is the nominal aspect ratio of the tyre, a load index LI satisfying H/LI≤1.00, preferably 0.72≤H/LI≤1.00 and more preferably 0.72≤H/LI≤0.95, where SW, AR and LI are defined according to the ETRTO Standards Manual, 2021. Thus, the invention is preferably applied to tyres that are likely to have relatively significant deflection because they have a relatively high load index for a sidewall height that is relatively low for this load index. Specifically, on account of the relatively significant deflection, the interface between the stiffening layer and the carcass layer is highly stressed and brings about energy dissipation that the invention advantageously makes it possible to control.

The nominal section width SW, the nominal aspect ratio AR, and the load index LI are notably indicated by the size marking inscribed on the sidewall of the tyre and in accordance with the ETRTO Standards Manual, 2021.

In some embodiments, the tyre comprising a carcass reinforcement comprising at least one carcass layer anchored in each bead, the crown comprising a crown reinforcement, the at least one carcass layer extending radially in each sidewall and axially in the crown radially to the inside of the crown reinforcement, the at least one carcass layer forms the reinforced layer. In these embodiments, the carcass layer forming the reinforced layer, the polymeric matrix is the calendering matrix of the carcass layer and the filamentary reinforcing elements are the filamentary reinforcing elements of the carcass layer.

Optionally, the carcass layer anchored in each bead is axially delimited by two axial ends of said carcass layer and comprises filamentary carcass reinforcing elements extending axially from one axial end to the other axial end of the carcass layer.

Optionally, each filamentary carcass reinforcing element extends in a main direction forming an angle with the circumferential direction of the tyre which, in terms of absolute value, is greater than or equal to 60°, preferably ranging from 80° to 90°.

In a first variant of the first configuration, the carcass reinforcement comprises a single carcass layer anchored in each bead and extending radially in each sidewall and axially in the crown radially to the inside of the crown reinforcement, the single carcass layer forming the reinforced layer.

In certain embodiments of this first variant, with the single carcass layer forming a winding around a circumferential reinforcing element of each bead such that an axially inner portion of the first carcass layer is arranged axially on the inside of an axially outer portion of the carcass layer and such that each axial end of the carcass layer is arranged radially on the outside of each circumferential reinforcing element, the part of the reinforced layer in contact with which the stiffening layer is arranged in said sidewall is formed by a part of the axially inner portion of the single carcass layer in said sidewall. In these embodiments, the axially outer portion of the carcass layer is relatively short. The stiffening layer is thus at least in contact with a part of the axially outer portion at least in the bead and with a part of the axially inner portion at least in said sidewall. Optionally, with the tyre comprising a filler layer arranged axially at least between the axially inner portion and the axially outer portion of the single carcass layer and extending radially from the circumferential reinforcing element to the crown of the tyre, the stiffening layer is thus also in contact with at least a part of the filler layer.

In other embodiments of this first variant, with the single carcass layer forming a winding around a circumferential reinforcing element of each bead such that an axially inner portion of the first carcass layer is arranged axially on the inside of an axially outer portion of the carcass layer and such that each axial end of the carcass layer is arranged radially on the outside of each circumferential reinforcing element, the part of the reinforced layer in contact with which the stiffening layer is arranged in said sidewall is formed by a part of the axially outer portion of the single carcass layer in said sidewall. In these embodiments, the axially outer portion of the carcass layer is relatively long. The stiffening layer is thus in contact with a part of the axially outer portion at least in the bead and with another part of the axially outer portion at least in said sidewall.

In other embodiments of this first variant, with each bead comprising at least first and second circumferential reinforcing elements, a portion of the carcass layer is arranged axially between two of the at least first and second circumferential reinforcing elements, for example as described in WO2021/123522.

In a second variant of the first configuration, the carcass reinforcement comprises first and second carcass layers, each first and second carcass layer being anchored in each bead and extending radially in each sidewall and axially in the crown radially to the inside of the crown reinforcement, one of the first and second carcass layers forming the reinforced layer.

In certain embodiments of this second variant, the first carcass layer forms a winding around a circumferential reinforcing element of each bead such that an axially inner portion of the first carcass layer is arranged axially on the inside of an axially outer portion of the first carcass layer and such that each axial end of the first carcass layer is arranged radially on the outside of each circumferential reinforcing element, and each axial end of the second carcass layer is arranged radially on the inside of each axial end of the first layer.

In a first alternative of these embodiments, each axial end of the second carcass layer is arranged axially between the axially inner and outer portions of the first carcass layer, the second carcass layer forming the reinforced layer. In this first alternative, the stiffening layer is thus at least in contact with a part of the axially outer portion of the first carcass layer at least in the bead and with a part of the second carcass layer at least in said sidewall. Optionally, with the tyre comprising a filler layer arranged axially at least between the axially inner portion and the axially outer portion of the first carcass layer and extending radially from the circumferential reinforcing element to the crown of the tyre, the stiffening layer is thus also in contact with at least a part of the filler layer.

In a second alternative of these embodiments, each axial end of the second carcass layer is arranged axially on the inside of each axially inner portion of the first carcass layer, the first carcass layer forming the reinforced layer. In this second alternative, the stiffening layer is thus at least in contact with a part of the axially outer portion of the first carcass layer at least in the bead and with a part of the first carcass layer at least in said sidewall. Optionally, with the tyre comprising a filler layer arranged axially at least between the axially inner portion and the axially outer portion of the first carcass layer and extending radially from the circumferential reinforcing element to the crown of the tyre, the stiffening layer is thus also in contact with at least a part of the filler layer.

In a third alternative of these embodiments, each axial end of the second carcass layer is arranged axially on the outside of each axially outer portion of the first carcass layer, the second carcass layer forming the reinforced layer. In this third alternative, the stiffening layer is thus at least in contact with a part of the second carcass layer at least in the bead and with another part of the second carcass layer at least in said sidewall.

In other embodiments of this second variant, each bead comprises a plurality of circumferential reinforcing elements, at least a portion of each first and second carcass layer being arranged axially between at least two circumferential reinforcing elements of the plurality of circumferential reinforcing elements, for example as described in WO2021/123522.

In a second configuration, the tyre comprises:
a carcass reinforcement comprising at least one carcass layer anchored in each bead, the crown comprising a crown reinforcement, the carcass layer extending radially in each sidewall and axially in the crown radially to the inside of the crown reinforcement,
a sidewall reinforcing layer arranged axially on the outside of the carcass reinforcement, the sidewall reinforcing layer forming the reinforced layer.

Unlike a carcass layer anchored in each bead, the sidewall reinforcing layer is not anchored in each bead. Thus, each radially inner end of the sidewall reinforcing layer is arranged radially on the outside of each bead. The sidewall reinforcing layer extends at least radially in each sidewall and has:
a radially inner end arranged radially on the inside of the equator of the tyre, and
a radially outer end arranged radially on the outside of the equator of the tyre.

In certain embodiments in which the single carcass layer or the first carcass layer forms a winding, each axial end of said carcass layer is arranged radially on the inside of the equator of the tyre and even more preferably arranged at a radial distance of less than or equal to 30 mm from a radially inner end of each circumferential reinforcing element of each bead. By arranging each axial end of the single carcass layer or of the first carcass layer on the inside of the equator of the tyre, the mass of the carcass reinforcement is significantly reduced. Furthermore, the vast majority of rims that are currently used for tyres for passenger vehicles have J-type flanges with a height which, in all cases, is less than 30 mm. The greatly preferred arrangement of each axial end in a region corresponding radially substantially to the rim flange makes it possible to mechanically protect each axial end. Specifically, if each axial end were arranged in the sidewall radially too far above each circumferential reinforcing element of each bead, that is to say at a radial distance significantly greater than 30 mm from the radially inner end of each circumferential reinforcing element, each axial end would then be in a flexible region of the tyre that is subjected to excessive stresses. In particular, such stresses are particularly high in the case of a tyre of the HIGH LOAD CAPACITY type.

In other embodiments in which the single carcass layer or the first carcass layer forms a winding, each axial end of said carcass layer is arranged radially on the outside of the equator of the tyre. Advantageously, in these other embodiments, each axial end of the single carcass layer or of the first carcass layer is very preferably arranged axially on the inside of an axial end of the or of at least one of the crown layer(s) of the crown reinforcement.

In some embodiments, the crown comprises a crown reinforcement comprising a working reinforcement comprising a radially inner working layer and a radially outer working layer arranged radially on the outside of the radially inner working layer.

Optionally, each working layer is axially delimited by two axial ends of said working layer and comprises working reinforcing elements extending axially from one axial end to the other axial end of said working layer, substantially parallel to one another.

Optionally, each working reinforcing element extends in a main direction forming an angle with the circumferential direction of the tyre which, in terms of absolute value, is strictly greater than 10°, preferably ranging from 15° to 50° and more preferably ranging from 20° to 35°.

Preferably, in the embodiments in which the working reinforcement comprises a radially innermost working layer and a radially outermost working layer arranged radially on the outside of the radially innermost layer, the main direction in which each working reinforcing element of the radially innermost working layer extends and the main direction in which each working reinforcing element of the radially outermost working layer extends form oppositely oriented angles with the circumferential direction of the tyre.

Optionally, the crown reinforcement comprises a hoop reinforcement axially delimited by two axial ends of the hoop reinforcement and comprising at least one hooping reinforcing element wound circumferentially in a helix so as to extend axially between the axial ends of the hoop reinforcement.

Preferably, the hoop reinforcement is arranged radially on the outside of the working reinforcement.

Preferably, the or each hooping reinforcing element extends in a main direction forming an angle with the circumferential direction of the tyre which, in terms of absolute value, is less than or equal than 10°, preferably less than or equal to 7° and more preferably less than or equal to 5°.

The invention will be understood better on reading the following description, which is provided purely by way of non-limiting example, with reference to the drawings, in which:

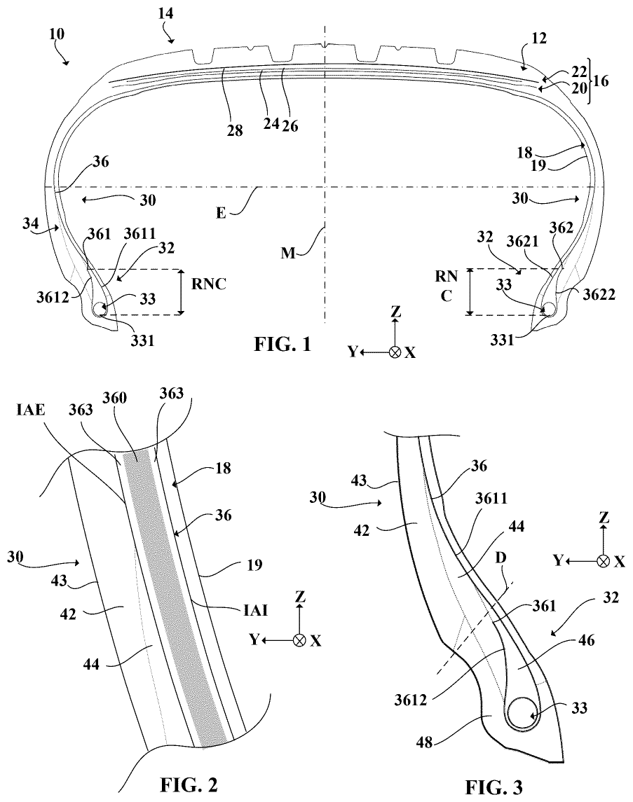

FIG. 1 is a view, in a meridian plane of section, of a tyre according to a first embodiment of the invention,

FIG. 2 is a detail view of one of the sidewalls of the tyre in FIG. 1,

FIG. 3 is a detail view of one of the beads and part of one of the sidewalls of the tyre in FIG. 1,

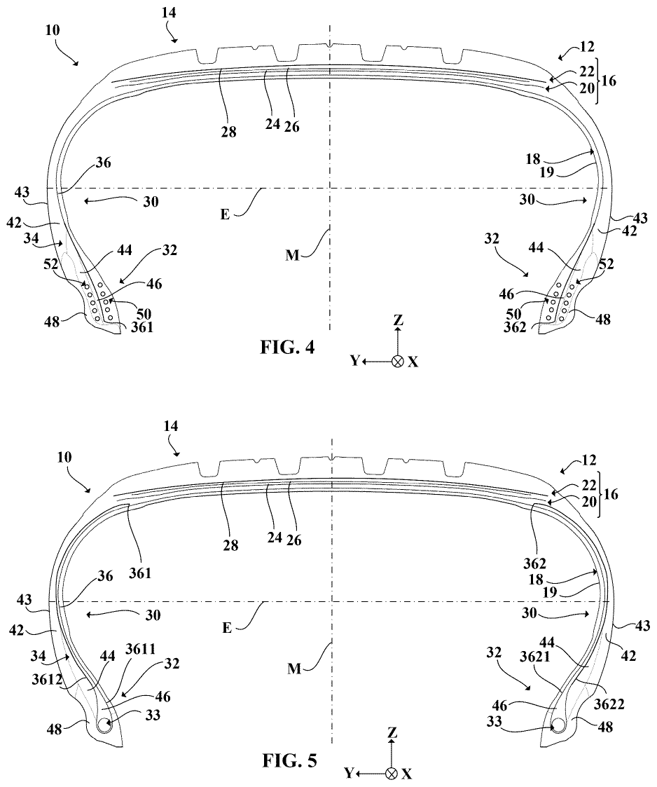

FIGS. 4 to 10 are views, similar to that in FIG. 1, of tyres according to second, third, fourth, fifth, sixth, seventh and eighth embodiments, respectively.

A frame of reference X, Y, Z corresponding to the usual axial (Y), radial (Z) and circumferential (X) directions, respectively, of a tyre or a mounted assembly is shown in the figures.

FIGS. 1 to 3 show a tyre according to the invention and denoted by the general reference 10. The tyre 10 has a substantially toroidal shape about an axis of revolution substantially parallel to the axial direction Y. The tyre 10 is intended for a passenger vehicle and is of the size 235/35 R19. In the various figures, the tyre 10 is shown as new, i.e. when it has not yet been run.

The tyre 10 comprises a crown 12 comprising a tread 14 intended to come into contact with the ground when it is running and a crown reinforcement 16 extending in the crown 12 in the circumferential direction X. The tyre 10 also comprises an airtight inner-liner 18 which is impervious to an inflation gas and is intended to delimit an internal cavity with a mounting support of the tyre 10, once the tyre 10 has been mounted on the mounting support, for example a rim, this cavity being intended to be pressurized with the inflation gas. The airtight inner-liner 18 bears an internal surface 19 of the tyre 10.

The crown reinforcement 16 comprises a working reinforcement 20 and a hoop reinforcement 22. The working reinforcement 20 comprises at least one working layer and, in this instance, two working layers comprising a radially inner working layer 24 and a radially outer working layer 26 arranged radially on the outside of the radially inner working layer 24.

The hoop reinforcement 22 comprises at least one hooping layer and, in this instance, one hooping layer 28.

The crown reinforcement 16 is arranged radially on the inside of the tread 14. In this instance, the hoop reinforcement 22, in this case the hooping layer 28, is arranged radially on the outside of the working reinforcement 20 and is therefore interposed radially between the working reinforcement 20 and the tread 14.

The tyre 10 comprises two sidewalls 30 that continue the crown 12 radially towards the inside. The tyre 10 also has two beads 32 radially inside the sidewalls 30. Each sidewall 30 connects each bead 32 to the crown 12. FIG. 3 shows the boundary between each bead 32 and each adjacent sidewall 30 by way of a dashed line D.

The tyre 10 comprises a carcass reinforcement 34. The crown reinforcement 16 is arranged radially between the tread 14 and the carcass reinforcement 34. The carcass reinforcement 34 comprises at least one carcass layer 36, in this case a single carcass layer 36, anchored in each bead 32. The carcass layer 36 extends radially in each sidewall 30 and axially in the crown 12 radially to the inside of the crown reinforcement 16.

The carcass layer 36 anchored in each bead 32 forms a winding around a circumferential reinforcing element 33 of each bead 32 such that an axially inner portion 3611, 3621 of the carcass layer 36 anchored in each bead 32 is arranged axially on the inside of an axially outer portion 3612, 3622 of the carcass layer 36 anchored in each bead 32 and such that each axial end 361, 362 axially delimiting the carcass layer 36 anchored in each bead 32 is arranged radially on the outside of each circumferential reinforcing element 33. Each axial end 361, 362 of the single carcass layer 36 anchored in each bead 32 is arranged radially on the inside of the equator E of the tyre. More precisely, each axial end 361, 362 of the carcass layer 36 anchored in each bead 32 is arranged at a radial distance RNC less than or equal to 30 mm from a radially inner end 331 of each circumferential reinforcing element 33 of each bead 32. In this case, RNC=23 mm.

Each working layer 24, 26, hooping layer 28 and carcass layer 36 comprises a polymeric matrix, in this case an elastomeric matrix, in which one or more reinforcing elements of the corresponding layer, in this case filamentary reinforcing elements, are embedded. The structure of the various layers and of the various reinforcing elements is conventional, as described, for example, in the applications WO2021250331, WO2022074341 or WO2022069819.

In particular, with reference to FIG. 2, the axially outermost reinforced layer in each sidewall 30, in this case the single carcass layer 36, comprises filamentary reinforcing elements 360 embedded in a polymeric matrix 363. The filamentary reinforcing elements 360 extend axially from one axial end to the other of the single carcass layer 36 in a main direction forming an angle with the circumferential direction X of the tyre 10 which, in terms of absolute value, is greater than or equal to 60°, preferably ranging from 80° to 90°, and in this case equal to 90°

The carcass layer 36 is separated from the adjacent layers with which its polymeric matrix 363 is in contact by an axially inner interface IAI and an axially outer interface IAE.

The polymeric matrix 363 of the carcass layer 36 has a modulus MA100R at 100% elongation such that MA100R≥1.0 MPa, preferably MA100R≥1.5 MPa and such that MA100R≤2.5 MPa, preferably MA100R≤2.0 MPa. In this case, MA100R=1.7 MPa.

Each sidewall 30 bears a marking indicating the size of the tyre 10. In this instance, the tyre 10 has a nominal section width SW equal to 235, a nominal aspect ratio AR equal to 35, and a nominal rim diameter equal to 19. The tyre 10 therefore has a sidewall height H defined by SW×AR/100 which in this case is equal to 82. The tyre 10 is an EXTRA LOAD version of size 235/35 R19 and has a load index equal to 91 as indicated on page 38 of the section “Passenger Car Tyres-Tyres with Metric Designation” of the ETRTO Standards Manual, 2021. The tyre 10 is such that 0.72≤H/LI≤1.00, preferably 0.72≤H/LI≤0.95, and in this case H/LI=0.90.

With reference to FIGS. 1 to 3, each sidewall 30 comprises an external layer 42 of said sidewall 30. Each external layer 42 bears an external surface 43. The tyre 10 comprises a stiffening layer 44 extending radially from each bead 32 into the sidewall 30 adjacent to each bead 32.

The tyre 10 comprises a filler layer 46 arranged axially at least between the axially inner portion 3611 and the axially outer portion 3612 of the single carcass layer 36 and extending radially from the circumferential reinforcing element 33 to the crown 12. The tyre 10 comprises a seating layer 48 for the tyre 10, which is intended to be in contact with a mounting support of the tyre 10 when the tyre 10 is mounted on a mounting support, for example a rim.

In this first embodiment, the single carcass layer 36 forms the reinforced layer. Thus, in each sidewall 30, each stiffening layer 44 is arranged axially between the single carcass layer 36 and the external layer 42 of the sidewall 30. In each sidewall 30, each stiffening layer 44 is arranged in contact with at least a part of the single carcass layer 36. In each sidewall 30, each stiffening layer 44 is arranged in contact with at least a part of the external layer 42.

Thus, the part of the reinforced layer in contact with which the stiffening layer 44 is arranged in each sidewall 30 is formed by a part of each axially inner portion 3611, 3621 of the single carcass layer 36 in each sidewall 30. Moreover, the stiffening layer 44 is in contact with a part of each axially outer portion 3612, 3622 in each bead 32 and with a part of the axially inner portion 3611, 3612 in each sidewall 30. The stiffening layer 44 is thus also in contact with a part of the filler layer 46.

In particular, the stiffening layer 44 has a modulus MA10B at 10% elongation such that MA10B≥30.0 MPa, preferably MA10B≥40.0 MPa and more preferably 40.0 MPa≤MA10B≤70.0 MPa. In this case, MA10B=48 MPa.

The polymeric matrix of the axially outermost reinforced layer in contact with which the stiffening layer 44 is arranged in each sidewall 30, in this instance the single carcass layer 36, and the stiffening layer 44 are such that the ratio R=MA100R/MA10B is such that R×1000≥(0.011×MA10B× MA10B)−1.71×MA10B+86.70, preferably R×1000≥(0.0106×MA10B×MA10B)−1.72×MA10B+90.40. Moreover, R is preferably such that Rx 1000≤(0.0127×MA10B×MA10B)−2.03×MA10B+109. In this case, 1000×R=35.42.

Tyres according to second, third, fourth, fifth, sixth, seventh and eighth embodiments will now be described with reference to FIGS. 4 to 10, respectively. Elements that are analogous to those shown in the preceding figures are designated by identical references.

Unlike the tyre according to the first embodiment, each bead 32 of the tyre 10 according to the second embodiment in FIG. 4 comprises at least first and circumferential reinforcing elements 50, 52. A portion of the single carcass layer 36 is arranged axially between the first and second circumferential reinforcing elements 50, 52.

Unlike the tyre according to the first embodiment, in the tyre 10 according to the third embodiment illustrated in FIG. 5, each axial end 361, 362 of the carcass layer 36 anchored in each bead and forming a winding is arranged radially on the outside of the equator E and even more preferably arranged axially on the inside of the axial ends of the working layer 24 and hooping layer 28 of the crown reinforcement 16. In this third embodiment, the part of the reinforced layer in contact with which the stiffening layer 44 is arranged in each sidewall 30 is formed by a part of each axially outer portion 3612, 3622 of the single carcass layer 36 in each sidewall 30. The stiffening layer 44 is in contact with a part of each axially outer portion 3612, 3622 in the bead 32 and with another part of the axially outer portion 3612, 3622 in each sidewall 30.

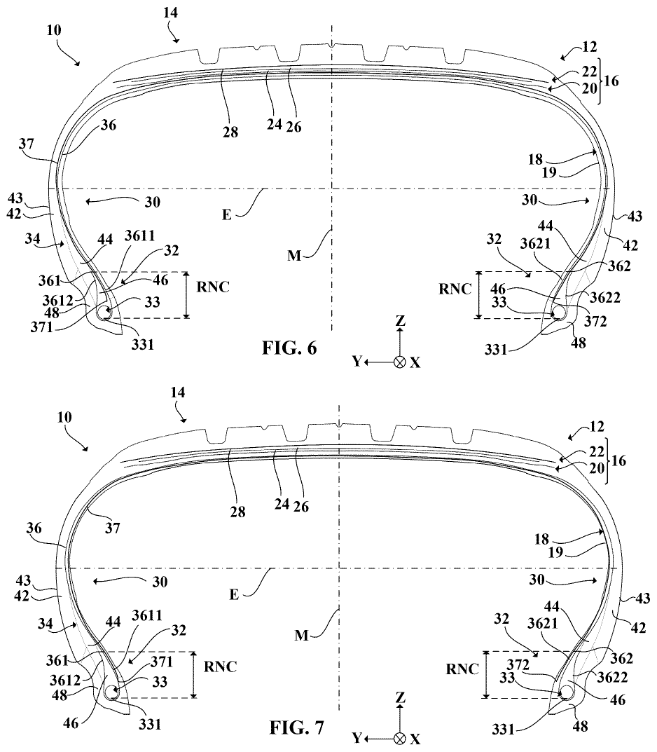

Unlike the tyre according to the first embodiment, the carcass reinforcement 34 of the tyre 10 according to the fourth embodiment in FIG. 6 comprises first and second carcass layers 36, 37 anchored in each bead 32. The first carcass layer 36 forms a winding around each circumferential reinforcing element 33 of each bead 32 such that an axially inner portion 3611, 3621 of the first carcass layer 36 is arranged axially on the inside of an axially outer portion 3612, 3622 of the first carcass layer 36 and such that each axial end 361, 362 of the first carcass layer 36 is arranged radially on the outside of each circumferential reinforcing element 33. Each axial end 371, 372 of the second carcass layer 37 is arranged radially on the inside of each axial end of the first layer 361, 362 and is arranged axially between the axially inner and outer portions 3611, 3612 and 3621, 3622 of the first carcass layer 36. The second carcass layer 37 in this case forms the reinforced layer in contact with which the stiffening layer 44 is arranged. The stiffening layer 44 is in contact with a part of the axially outer portion 3612, 3622 of the first carcass layer 36 in each bead 32 and with a part of the second carcass layer 37 in each sidewall 30. The stiffening layer 44 is also in contact with a part of the filler layer 46.

Unlike the tyre according to the fourth embodiment, in the tyre 10 according to the fifth embodiment illustrated in FIG. 7, each axial end 371, 372 of the second carcass layer 37 is arranged axially on the inside of each axially inner portion 3611, 3621 of the first carcass layer 36. The first carcass layer 36 in this case forms the reinforced layer in contact with which the stiffening layer 44 is arranged. The stiffening layer 44 is in contact with a part of each axially outer portion 3612, 3622 of the first carcass layer 36 in each bead 32 and with a part of the first carcass layer 36 in each sidewall 30. The stiffening layer 44 is also in contact with a part of the filler layer 46.

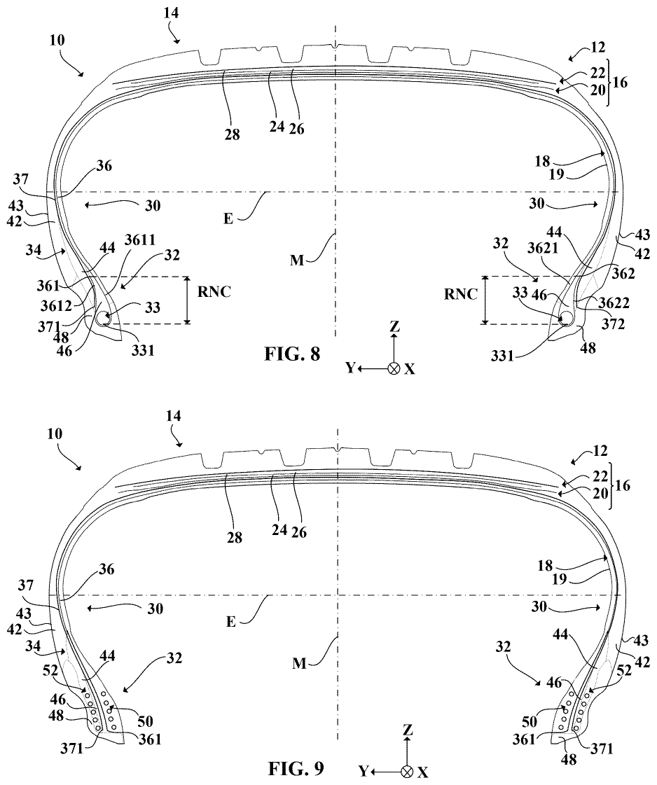

Unlike the tyre according to the fourth embodiment, in the tyre 10 according to the sixth embodiment illustrated in FIG. 8, each axial end 371, 372 of the second carcass layer 37 is arranged axially on the outside of each axially outer portion 3612, 3622 of the first carcass layer 36. The second carcass layer 37 in this case forms the reinforced layer. The stiffening layer 44 is in contact with a part of the second carcass layer 37 in each bead 32 and with another part of the second carcass layer 37 in each sidewall 30.

Unlike the tyre according to the fourth embodiment, in the tyre 10 according to the seventh embodiment illustrated in FIG. 9, each bead 32 comprises a plurality of circumferential reinforcing elements 50, 52. At least a portion of each first and second carcass layer 36, 37 is arranged axially between two circumferential reinforcing elements of the plurality of circumferential reinforcing elements 50, 52.

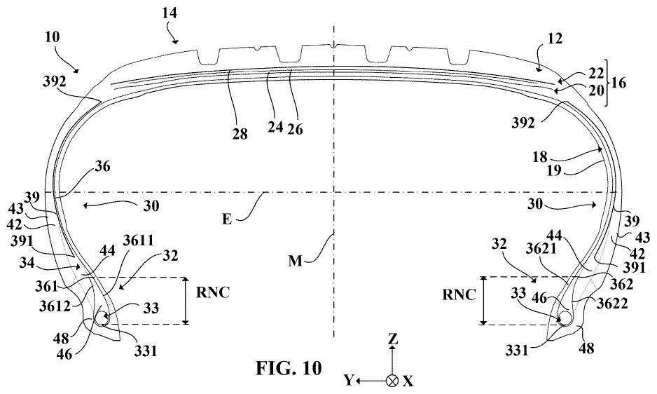

Unlike the tyre according to the first embodiment, in the tyre 10 according to the eighth embodiment illustrated in FIG. 10, the tyre 10 comprises two sidewall reinforcing layers 39 arranged axially on the outside of the carcass reinforcement 34. Each sidewall reinforcing layer 39 extends at least radially in each sidewall 30 and has a radially inner end 391 arranged radially on the inside of the equator E and a radially outer end 392 arranged radially on the outside of the equator E. Each radially inner end 391 of each sidewall reinforcing layer 39 is arranged radially on the outside of each bead 32 and is therefore not anchored therein. The sidewall reinforcing layer 39 in this case forms the reinforced layer.

### Comparative Tests

Two tyres were made to run in a running test similar to the load/speed performance test described in Annex VII of UNECE Regulation No 30, but under even more demanding conditions. The two tyres had an architecture similar to that of the fourth embodiment described with reference to FIG. 6. The two tyres comprised identical stiffening layers having a modulus MA10B at 10% elongation equal to 48 MPa.

The first, control tyre of size 235/35R19, not according to the invention, comprised a first carcass layer having a modulus MA100R at 100% elongation of the polymeric matrix equal to 1.2 MPa such that the value of 1000×R is equal to 25.00, which is below the threshold of the invention, calculated as being 29.96.

The second tyre, of the same size 235/35R19, according to the invention, comprised a first carcass layer having a modulus MA100R at 100% elongation of the polymeric matrix equal to 1.6 MPa such that the value of 1000×R is equal to 33.33, which is above the threshold of the invention, calculated as being 29.96.

The compositions of the corresponding polymeric matrices are described in the table below. The compositions were prepared under conventional compounding conditions and were vulcanized under likewise conventional conditions in the field of tyres, in this case between 160° and 165° for 15 minutes.

| | | Composition of the |
|---|---|---|
| | Composition of the | polymeric matrix of |
| | polymeric matrix of | the first carcass layer |
| Constituents | the first carcass layer | of the tyre according |
| (in phr) | of the control tyre | to the invention |
| NR (1) | 75 phr | 75 phr |
| SBR (2) | 25 phr | 25 phr |
| N375 (3) | 20 phr | 20 phr |
| N550 (4) | 20 phr | 20 phr |
| Oil (5) | 5 phr | 5 phr |
| Sulfur | 1.6 phr | 3.2 phr |
| CBS (6) | 1.1 phr | / |
| TBBS (7) | / | 0.7 phr |
| ZnO (8) | 3 phr | 1 phr |
| Stearic acid (9) | 1 phr | 1 phr |
| 6PPD (10) | 2 phr | 2 phr |

(1)-Natural rubber; (2)-SBR with 26% styrene units, 24% vinyl units and 47% 1-4trans units, Tg:-54° C.; (3) and (4)-Carbon black of ASTM grade according to the standard D-1765; (5)-High Quality Rubber Process Oil (Vivatec 500); (6)-N-cyclohexyl-benzothiazyl sulfenamide (Santocure CBS from Flexsys); (7)-N-ter-butyl-2-benzothiazyle sulfenamide (sold by Flexsys); (8)-Zinc oxide (industrial grade-sold by Umicore); (9)-Stearin (“Pristerene 4931” sold by Uniqema); (10) N-1,3-dimethylbutyl-N-phenylparaphenylenediamine (Santoflex 6-PPD sold by Flexsys).

After 31000 km of running on a rolling-road machine, the control tyre exhibited traces of significant heating of the interface between the stiffening layer and the first carcass layer. The tyre according to the invention did not exhibit any trace of unusual heating of this same interface.

The invention is not limited to the above-described embodiments.

Specifically, as described above, the invention could advantageously be applied to tyres of the HIGH LOAD CAPACITY type. For such tyres, the marking comprises a load index LI such that LI≥LI′+1, where LI′ is the load index of an EXTRA LOAD tyre of the same size according to the ETRTO Standards Manual, 2021. Preferably, LI′+1≤LI≤LI′+4, and even LI′+2≤LI≤LI′+4. As described above, the tyre of size 235/35R19 in its EXTRA LOAD version exhibits a load index equal to 91. Thus, the load index LI of the tyre of size 235/35R19 in its HIGH LOAD CAPACITY version is such that LI≥92, preferably 92≤LI≤95 and even 93≤LI≤95, and in this case LI=94. The tyre in its HIGH LOAD CAPACITY version is such that 0.72≤H/LI≤1.00, preferably 0.72≤H/LI≤0.95, and in this case H/LI=0.88.

1.-13. (canceled)

14. A tire for a passenger vehicle, comprising:
a crown, two beads, two sidewalls connecting each bead to the crown, each sidewall comprising an external layer of the sidewall bearing an external surface of the sidewall;
a reinforced layer extending radially in at least one of the sidewalls and comprising filamentary reinforcing elements embedded in a polymeric matrix;
a stiffening layer extending radially from one of the beads into the sidewall adjacent to the one of the beads, the stiffening layer being arranged, in the sidewall:
axially between the reinforced layer and the external layer of the sidewall, and
in contact with at least a part of the reinforced layer and in contact with at least a part of the external layer of the sidewall,
wherein a ratio R of a modulus MA100R at 100% elongation of the polymeric matrix of the reinforced layer to a modulus MA10B at 10% elongation of the stiffening layer is such that R×1000≥(0.011×MA10B×MA10B)−1.71×MA10B+86.70.

15. The tire according to claim 14, wherein R×1000≥(0.0106×MA10B×MA10B)−1.72×MA10B+90.40.

16. The tire according to claim 14, wherein R×1000≤(0.0127×MA10B×MA10B)−2.03×MA10B+109.

17. The tire according to claim 14, wherein MA10B≥30.0 MPa.

18. The tire according to claim 14, wherein MA100R≥1.0 MPa.

19. The tire according to claim 14, wherein MA100R≤2.5 MPa.

20. The tire according to claim 14, wherein the tire is a high load capacity type tire according to ETRTO Standards Manual, 2021.

21. The tire according to claim 14, wherein the tire has a sidewall height H defined by H=SW×AR/100 where SW is a nominal section width and AR is a nominal aspect ratio of the tire and a load index LI satisfying H/LI≤1.00, where SW, AR and LI are defined in accordance with ETRTO Standards Manual, 2021.

22. The tire according to claim 14, further comprising a carcass reinforcement comprising at least one carcass layer anchored in each bead, the crown comprising a crown reinforcement, the at least one carcass layer extending radially in each sidewall and axially in the crown radially to an inside of the crown reinforcement, the at least one carcass layer forming the reinforced layer.

23. The tire according to claim 22, wherein the carcass reinforcement comprises a single carcass layer anchored in each bead and extending radially in each sidewall and axially in the crown radially to the inside of the crown reinforcement, the single carcass layer forming the reinforced layer.

24. The tire according to claim 23, wherein, with the single carcass layer forming a winding around a circumferential reinforcing element of each bead such that an axially inner portion of the first carcass layer is arranged axially on an inside of an axially outer portion of the carcass layer and such that each axial end of the carcass layer is arranged radially on an outside of each circumferential reinforcing element:
the part of the reinforced layer in contact with which the stiffening layer is arranged in the sidewall is formed by a part of the axially inner portion of the single carcass layer in the sidewall, or
the part of the reinforced layer in contact with which the stiffening layer is arranged in the sidewall is formed by a part of the axially outer portion of the single carcass layer in the sidewall.

25. The tire according to claim 22, wherein the carcass reinforcement comprises first and second carcass layers, each first and second carcass layer being anchored in each bead and extending radially in each sidewall and axially in the crown radially to the inside of the crown reinforcement, one of the first and second carcass layers forming the reinforced layer.

26. The tire according to claim 25, wherein the first carcass layer forms a winding around a circumferential reinforcing element of each bead such that an axially inner portion of the first carcass layer is arranged axially on an inside of an axially outer portion of the first carcass layer and such that each axial end of the first carcass layer is arranged radially on an outside of each circumferential reinforcing element, and each axial end of the second carcass layer is arranged radially on an inside of each axial end of the first layer and:
axially between the axially inner portion and axially outer portion of the first carcass layer, the second carcass layer forming the reinforced layer, or
axially on an inside of each axially inner portion of the first carcass layer, the first carcass layer forming the reinforced layer, or
axially on an outside of each axially outer portion of the first carcass layer, the second carcass layer forming the reinforced layer.
